(19) United States
(12) Patent Application Publication
(10) Pub. No.: US 2003/0197688 A1
(43) Pub. Date: Oct. 23, 2003

(54) User interface

(75) Inventors: Brian E. Aufderheide, Cedarburg, WI (US); Paul D. Frank, Oak Creek, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/127,099

(22) Filed: Apr. 22, 2002

(51) Int. Cl. G09G 5/00

(52) U.S. Cl. 345/173

(57) ABSTRACT

A resistive touch panel including a base layer is disclosed. The touch panel includes a resistive layer covering the active area of the touch panel. The touch panel also includes a plurality of electrodes disposed to induce a voltage gradient across the resistive layer. The touch panel also includes a linearization pattern comprising a plurality of resistors disposed over at least a portion of the resistive layer for maintaining the uniformity of the voltage gradient across the resistive layer. The touch panel also includes an insulator covering a least a portion of the linearization pattern. The insulator reduces changes in the voltage gradient over time. A method of making a resistive touch screen is also disclosed.

### FIELD OF THE INVENTION

The present invention relates to a user interface. The present invention also relates to a resistive touch screen having an insulator layer for stabilizing the resistance of a linearization pattern.

### BACKGROUND

A five wire (5-wire) resistive touch screen is known. Such touch screen includes a hard-coated polyester cover sheet with a conductive coating that is overlaid on a glass layer having a conductive coating. A voltage is typically applied to the cover sheet. When a user provides an input to the touch screen (e.g. a “touch” with a finger, stylus, etc.), the cover sheet conductive coating depresses into contact with the base sheet conductive coating (e.g. glass layer). Current then flows from the touch position to electrodes of the four corners of the base sheet in proportion to the distance from the perimeter of the touch screen. A controller then calculates the position of the input based on the current flows.

A problem associated with such 5-wire resistive touch screen is that upon application of an electric field, via the corner electrodes, bowing of the equipotential lines occurs near the edges and corners of the active region. This can disadvantageously make the touch panel response non-uniform. One solution to this problem is to add a “linearization” pattern that includes a pattern of resistors to counteract the bowing of the equipotential line.

Inks and adhesives are typically printed over the linearization pattern to protect from damage and to complete the assembly of the touch screen. However, such inks and adhesives can cause a substantial increase in the resistance of the linearization pattern. Further, degradation of the linearization pattern over time (e.g. due to exposure to temperature, humidity, etc.) may change the linearity of the equipotential lines generated by the electrodes, resulting in misidentification of the position of the input or touch. For example, if the glass layer has a sheet resistivity of about 400 Ohm/square, a change in the linearization pattern measured from corner electrode pair to corner electrode pair of 23 Ohms will produce a position change of approximately 1% (i.e. error).

### SUMMARY OF THE INVENTION

The present invention relates to a resistive touch panel having an insulator covering at least a portion of a linearization pattern, which reduces fluctuations in the linearity of the voltage gradient over time. The present invention also relates to a resistive touch panel having an insulator wherein the resistance of a plurality of resistors increases less than about 30% at 60° C. and 95% RH after two weeks.

The present invention also relates to a resistive touch panel including a base layer. The touch panel includes a resistive layer covering the active area of the touch panel. The touch panel also includes a plurality of electrodes disposed to induce a voltage gradient across the resistive layer. The touch panel also includes a linearization pattern comprising a plurality of resistors disposed over at least a portion of the resistive layer for maintaining the uniformity of the voltage gradient across the resistive layer. The touch panel also includes an insulator covering a least a portion of the linearization pattern. The insulator reduces changes in the voltage gradient over time.

The present invention also relates to an electronic display including a touch panel. The display includes a linearization pattern comprising a plurality of resistors disposed to straighten a voltage gradient induced by electrodes coupled to a resistive layer. The display also includes an insulator covering at least a portion of the linearization pattern. The insulator reduces changes in the voltage gradient over time.

The present invention also relates to a method of making a resistive touch screen. The touch screen includes a base layer, a plurality of electrodes of the base layer separated by a resistor, and an insulator coupled to the resistor. The method includes applying the insulator to the resistor. The insulator does not substantially increase the resistance of the resistor at ambient temperature and humidity.

The present invention also relates to a resistive touch screen. The touch screen includes a base layer coupled to a flexible layer by a fastener. The touch screen also includes a linearization region comprising a plurality of resistors between a first conductor and a second conductor for reducing a bow of a voltage gradient between the first conductor and the second conductor. The touch screen also includes an insulator means for maintaining the resistance of the plurality of resistors.

### FIGURES

FIG. 1 is a schematic view of a user interface according to an exemplary embodiment.

FIG. 2 is a perspective view of a user interface according to an alternative embodiment.

FIG. 3 is an exploded perspective view of the user interface of FIG. 2.

FIG. 4 is a cross-sectional view of the user interface of FIG. 2 along line 4-4 of FIG. 2.

### DETAILED DESCRIPTION OF EXEMPLARY EMBODIMENTS

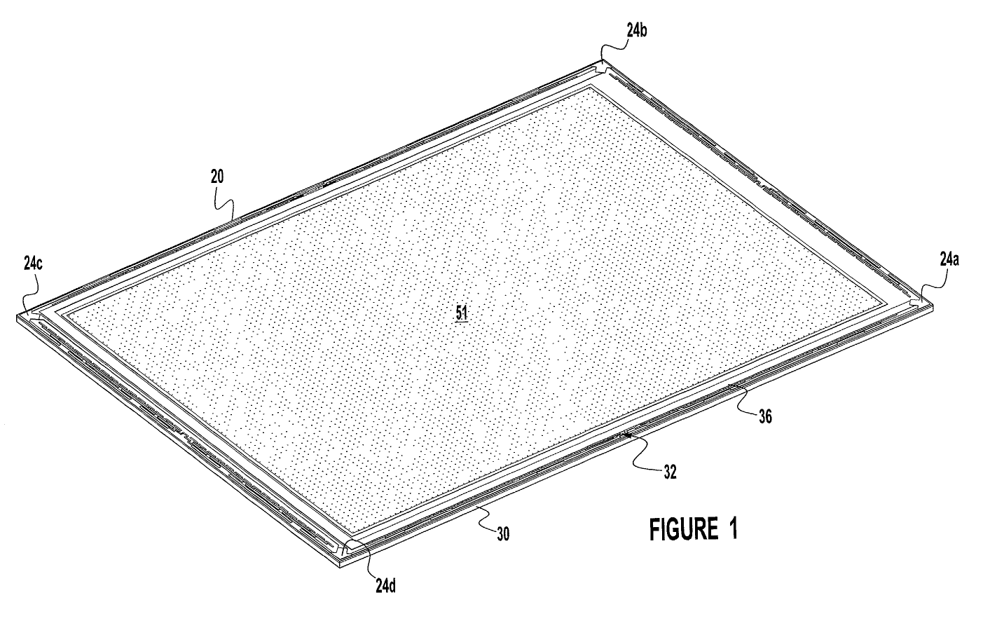

A user interface is schematically shown as a 5-wire resistive touch screen 10 in FIG. 1. A user may input or view information by touching or pressing a use or active region 51 of touch screen 10. Touch screen 10 includes a flex layer 20 attached to a base layer 30. An insulator layer 36 is shown printed over a linearization pattern 32 between each of electrodes 24a through 24d. The present inventors were the first to appreciate and discover an insulator layer that protects the linearization pattern, reduces linearity “drift” over time, and minimally increases resistance.

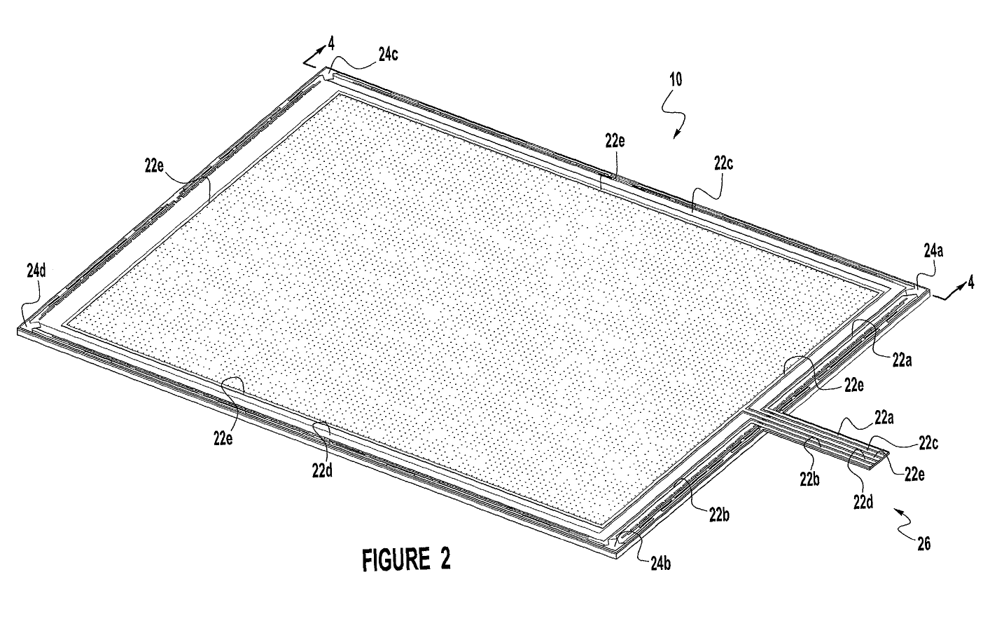

FIG. 2 shows touch screen 10 according to an alternative embodiment. Touch screen 10 may be relatively transparent for viewing of information generated by a display system such as a computer monitor.

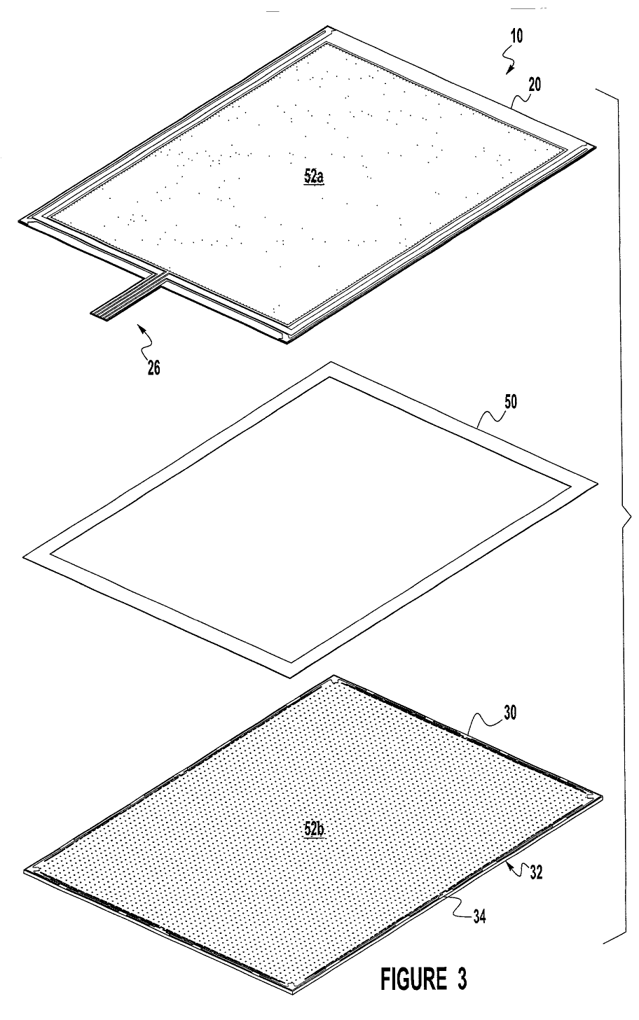

Referring to FIG. 3, touch screen 10 is shown having a “sandwiched” or layered construction. Touch screen 10 includes a deformable cover or top sheet (shown as polyester flex layer 20). A fastener or acid-free spacer adhesive layer 50 mechanically attaches flex layer 20 to an opposing base layer (shown as a base glass stable layer 30). Both flex layer 20 and base layer 30 are coated with a continuous layer of transparent conductor material (such as tin oxide (“TO”), indium tin oxide (“ITO”) or similar transparent conductive material, and shown as layers 52a and 52b (respectively) according to any preferred or alternative embodiments According a preferred embodiment as shown in FIG. 3, flex layer 20 and/or base layer 30 includes a supplemental layer shown as a spacer dot layer 38. According to alternative embodiments, the base layer may have an etched glass surface. According to another alternative embodiment, the supplemental layer may be a clear or antiglare scratch-resistant hardcoat layer to prevent Newton's Rings between the flex and the base layer.

Five “wires” or conductive traces of silver ink (shown as traces 22a through 22e) are shown in FIGS. 2 and 3. Traces 22a through 22d are electrically connected to electrodes 24a through 24d, respectively, located at each of the corners of flex layer 20. Electrodes 24a through 24d each have a voltage potential (e.g. 0-5 volts along the x-axis or 0-5 volts along the y-axis), and work in opposite pairs to set up a voltage gradient (according to a preferred embodiment). According to an alternative embodiment, a voltage gradient may be provided between a first electrode having a first potential and a second adjacent electrode having a second potential.

The electrodes electrically couple flex layer 20 to base layer 30 when active region 51 is actuated (i.e. a “switch” or circuit between the flex layer and the base layer is closed or completed). Electrically conductive trace 22e circumscribes the perimeter of flex layer 20 (e.g. in a “picture frame” configuration) to “pick” or read voltages from base layer 30. Flex layer 20 also includes a mounting interface (shown as a tail 26 in FIG. 2) for connection to decoding electronics, an accessory such as a monitor (e.g. LCD, CRT, etc.), computer, etc.

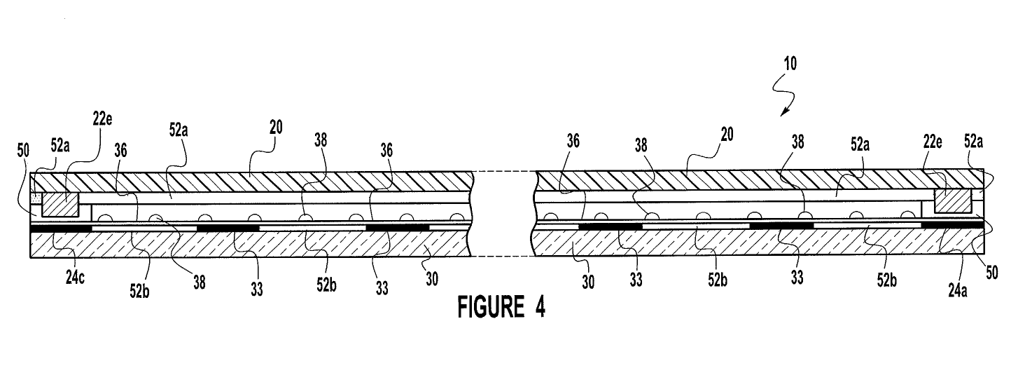

Referring further to FIG. 3, base layer 30 includes linearization or resistor pattern 32 for minimizing the “bow” or curvature of the voltage gradient between the corner electrodes. Resistor pattern 32 includes discontinuous segments of silver conductive ink 33, or other suitable conductive material, and resistors (see FIG. 4). According to a particularly preferred embodiment, the ink of the resistor pattern is silver filled conductive epoxy ink commercially available from Ercon, and is about 10,000 times more conductive than the ITO or TO resistors.

In the spaces or gaps 34 between the discontinuous segments of conductive ink 33 TO/ITO layer 52b is the conductive medium. Gaps 34 function as resistors to assist in “linearizing” or minimizing the bow of the voltage gradient between the corner electrodes. A control program (e.g. hardware and/or software correction factors and algorithms) corrects or straightens the bow of the voltage gradient remaining after resistor pattern 32 is printed, according to a preferred embodiment. According to a particularly preferred embodiment, the resistance of resistor pattern 32 is between about 85 and 212 Ohm, and may be increased or decreased based in part on the controller, the TO/ITO sheet resistance, and other materials of the touch screen.

Referring to FIG. 4, insulator ink layer or insulator means 36 is shown screen printed or coated over resistor pattern 32 (see also FIG. 2). Insulator 36 inhibits shorting of the ink traces or circuitry on flex layer 20 and base layer 30. The presence of the insulator after printing or applying, drying and curing does not substantially increase the resistance of the resistor pattern. During manufacturing, and about one hour to one day after applying, drying, curing and cooling of the insulator, the resistance of the resistors between two adjacent corner electrodes does not substantially increase (and may decrease). Further, the resistance of the resistors may not substantially increase after exposure to ambient temperature and humidity for a relatively long period (i.e. about three months). The insulator increases the resistance of the resistor pattern by less than about 100% at ambient temperature and humidity one hour after applying, drying, curing, and F cooling the insulator, preferably less than about 30%, preferably less than about 15%, preferably less than about 10%, preferably less than about 5% according to preferred and alternative embodiments.

The presence of the insulator after printing and curing also protects the resistor pattern from degradation (e.g. oxidation) and “stabilizes” or maintains the conductivity/resistance of resistor pattern 32 (i.e. reduces “drift” or fluctuation changes in the resistance). The insulator increases the resistance of the resistor pattern by less than about 30% at 60° C. and 95% RH after two weeks, preferably less than about 15% according to a preferred embodiment.

Without intending to be limited to any particular theory, such degradation of the resistor pattern could be caused by oxidation, reduction, or etching of the ITO/TO coating due to: (1) exposure to extreme temperature or water (e.g. humidity) or corrosive materials from the environment (e.g. ozone, sulfur, etc.); (2) chemical interactions with components of the touch screen having oxidants (e.g. peroxides, polymerization initiators, etc.); (3) acids (e.g. acrylic acid in acrylic adhesives, etc.); (4) acid decomposition products (e.g. from peroxide or polyvinyl chloride decomposition); and/or (5) mechanical stress (e.g. caused by relative differences in thermal and hygroscopic coefficients of expansion, or shrinkage of materials mechanically in contact with the resistor pattern), etc.

The insulator is a UV radiation cured (e.g. polymerized) acrylate/methacrylate material, according to a preferred embodiment as shown in FIG. 3. The insulator does not include substantial amounts of materials that adversely affect or degrade the resistance of the resistor pattern such as oxidizing agents, acids, solvents (e.g. acidic, oxidative, etc.), etc. According to a particularly preferred embodiment, the insulator is Electrodag 452SS ultraviolet curable dialectic coating (“452SS”) or PF-455 ultraviolet curable dielectric coating (“PF455”), each commercially available from Acheson Colloids Company of Port Huron, Mich. The PF455 UV curing dielectric coating includes polybutadiene, acrylate/methacrylate resin, dicyclopentenyloxyethyl acrylate, and a photoinitiator, a siloxane/silica compound and talc. The 452SS UV curable dielectric coating includes 1,6 hexanediol diacrylate, acrylate oligomer, dicyclopentenyloxyethyl acrylate, photoinitiator, a silicone compound, talc and a thermoplastic polymer. According to alternative embodiments, the insulator may be an epoxy or isocyanate/urethane, and may be cured by heat, solvent evaporation, etc. The insulator is relatively transparent when cured by UV radiation according to a preferred embodiment, and may be tinted or opaque according to alternative embodiments.

### EXAMPLES

Touch screen samples were prepared using 3 mm thick etched soda lime glass sheets commercially available from Glaverbel SA of Belgium. The glass was coated with ITO, having a resistance of 400 to 600 Ohms/square, commercially available from Applied Films, Inc. of Boulder, Colo. A resistor pattern of silver filled conductive ink commercially available from Ecron having a thickness of about 0.0004 inch thick was printed around the perimeter of the glass sheets. The glass sheets were dried in a forced air oven. The resistance from one corner to an adjacent corner electrode through the resistor pattern was about 100 Ohms.

### Example 1

The resistor pattern of one sample was printed with about 0.0004 inch thick of insulating epoxy commercially available from the Enthone, Inc. of New Haven, Connecticut, and then cured in a forced air oven at about 180° C. The resistance from one corner electrode to an adjacent corner electrode through the resistor pattern changed about 500 Ohms. The resistor pattern of another sample was printed with about 0.001″ thick PF455 ink and UV cured. The change in resistance from one corner electrode to an adjacent corner electrode through the resistor pattern was less than about 100 Ohms.

### Example 2

The resistor pattern of one sample was printed with about 0.0011 inch thick of solvent based, peroxide cured, silicone pressure sensitive adhesive (PSA), then dried and cured in a forced air oven at about 90° C. followed by 180° C. The resistor pattern of another sample was printed with about 0.001 inch thick PF455 ink and then UV cured. The resistor pattern of another sample was printed with about 0.001 inch thick PF452 ink and then UV cured. The change in resistance from one corner electrode to an adjacent corner electrode through the resistor pattern of each of the samples shortly after curing and cooling is shown in TABLE 1.

TABLE 1

| | Change in Resistance after |
|---|---|
| Insulator over | Drying/Cure at 90° C./180° C., |
| resistor pattern | ambient (low) RH |
| solvent based PSA/silver | +92% |
| PF455/silver | −4.1% |
| PF452/silver | −5.1% |

### Example 3

The resistor pattern of one sample was printed with about 0.001 inch thick PF455 ink and then UV cured. The resistor pattern of another sample was printed with about 0.001 inch thick PF452 ink and then cured. The change in resistance from one corner electrode to an adjacent corner electrode through the resistor pattern of each of the samples after two weeks is shown in TABLE 2.

TABLE 2

| | Room temperature and | | |
|---|---|---|---|
| | relative humidity | | |
| Insulator over | (approximately 21° C.- | 60° C./ | 85° C., ambient |
| resistor pattern | 23° C./30-50% RH) | 95% RH | (low) RH |
| Unprotected | +1.4% | +63.9% | +2.3% |
| silver | | | |
| PF455/silver | 0% | +11.6% | −3.3% |
| PF452/silver | −0.2% | +26.2% | −10.8% |

### Example 4

The resistor pattern of one sample was printed with about 0.001″ thick PF455 ink and then UV cured. The resistor pattern of another sample was not printed with an insulator. The samples were assembled into completed 5-wire touch screens using an acid free acrylic spacer adhesive and a support acrylic PSA flex layer. The change in resistance from one corner electrode to an adjacent corner electrode through the resistor pattern of each of the samples after two weeks is shown in TABLE 3.

TABLE 3

| Insulator | Room temperature and | | |
|---|---|---|---|
| over | relative humidity | | 85° C., |
| resistor | (approximately 21° C.- | 60° C./ | ambient |
| pattern | 23° C./30-50% RH) | 95% RH | (low) RH |
| None | +0.5% | +84.6% | −2.6% |
| PF455 | −0.06% | +13.2% | −2.6% |

### Example 5

The resistor pattern of one sample was printed with PF455 ink and then UV cured. The resistor pattern of another sample was not printed with an insulator. The samples were assembled into a completed 5-wire touch screen using an acrylic PSA and flex layer. The change in resistance from one corner electrode to an adjacent corner electrode through the resistor pattern of each of the samples after two weeks is shown in TABLE 4.

TABLE 4

| Insulator over | Room temperature and relative humidity | 60° C./ |
|---|---|---|
| resistor pattern | (approximately 21° C.-23° C./30-50% RH) | 95% RH |
| None | +1.4% | +63.9% |
| PF455 | 0% | +11.6% |

### Example 6

The resistor pattern of a 5-wire touch screen sample having a base layer including a continuous ITO layer was printed with PF455 ink and then UV cured. The resistor pattern of another 5-wire touch screen sample having a base layer including a continuous ITO layer was not printed with an insulator. The change in resistance from one corner electrode to an adjacent corner electrode through the resistor pattern of each of the samples after two weeks is shown in TABLE 5.

TABLE 5

| | Room temperature and relative humidity | |
|---|---|---|
| Insulator over | (approximately | 60° C./ |
| resistor pattern | 21° C.-23° C./30-50% RH) | 95% RH |
| None | +0.87% | +114% |
| PF455 | −0.42% | +12.3% |

Although only a few embodiments of the present inventions have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, colors, orientations, protocols, etc.) without materially departing from the novel teachings and advantages of the subject matter recited in the claims. For example, the user interface screen may be a 4-wire or 8-wire resistive touch screen or a matrix touch screen according to alternative embodiments. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions as expressed in the appended claims.

What is claimed is:

1. A resistive touch panel having an active area and including a base layer comprising:
a resistive layer covering the active area of the touch panel;
a plurality of electrodes disposed to induce a voltage gradient across the resistive layer;
a linearization pattern comprising a plurality of resistors disposed over at least a portion of the resistive layer for maintaining the uniformity of the voltage gradient across the resistive layer; and
an insulator covering a least a portion of the linearization pattern;
wherein the insulator reduces changes in the voltage gradient over time.

2. The resistive touch panel of claim 1 wherein the resistance of the plurality of resistors increases less than about 30% at 60° C. and 95% RH after two weeks.

3. The resistive touch panel of claim 2 wherein the resistance of the plurality of resistors increases less than about 15% at 60° C. and 95% RH after two weeks.

4. The resistive touch panel of claim 3 wherein the resistance of the plurality of resistors increases less than about 5% at 60° C. and 95% RH after two weeks.

5. The resistive touch panel of claim 5 wherein the insulator does not substantially increase the resistance of the plurality of resistors at ambient temperature and ambient humidity.

6. The resistive touch panel of claim 1 wherein the resistance of the plurality of resistors does not substantially increase after curing the insulator.

7. The resistive touch panel of claim 6 wherein the resistance of the plurality of resistors increases by less than 5% about one day after curing the insulator.

8. The resistive touch panel of claim 5 wherein the insulator increases the resistance of the voltage gradient by less than about 5% at ambient temperature and ambient humidity after two weeks.

9. The resistive touch panel of claim 8 wherein the insulator increases the resistance of the plurality of resistors by less than about 5% at ambient temperature and ambient humidity after thirty days.

10. The resistive touch panel of claim 9 wherein the insulator inhibits upward drift of the resistance of the plurality of resistors.

11. The resistive touch panel of claim 10 wherein the insulator comprises an ink.

12. The resistive touch panel of claim 11 wherein the insulator is transparent.

13. The resistive touch panel of claim 12 wherein the insulator comprises an acrylate monomer configured to polymerize when exposed to UV radiation.

14. The resistive touch panel of claim 10 wherein the resistors are disposed over the periphery of the resistive layer.

15. The resistive touch panel of claim 14 further comprising a flexible layer coupled to the base layer by a fastener.

16. The resistive touch panel of claim 15 wherein the resistive layer comprises indium tin oxide.

17. The resistive touch panel of claim 16 wherein the linearization pattern comprises a plurality of discontinuous segments of conductive ink positioned proximate the perimeter of the base layer and separated by the plurality of resistors.

18. The resistive touch panel of claim 17 wherein the conductive ink of the linearization pattern has a greater conductivity than the conductivity of the plurality of resistors.

19. The resistive touch panel of claim 18 wherein the plurality of resistors comprises a conductive coating that is continuous over the base layer and further comprises at least one of tin oxide and indium tin oxide.

20. An electronic display including a touch panel comprising:
a linearization pattern comprising a plurality of resistors disposed to straighten a voltage gradient induced by electrodes coupled to a resistive layer;
an insulator covering at least a portion of the linearization pattern;
wherein the insulator reduces changes in the voltage gradient over time.

21. The electronic display of claim 20 wherein the resistance of the plurality of resistors increases by less than about 30% at 60° C. and 95% RH after two weeks.

22. The electronic display of claim 21 wherein the resistance of the plurality of resistors increases the resistance of the plurality of resistors by less than about 15% at 60° C. and 95% RH after two weeks.

23. The electronic display of claim 20 wherein the insulator is a UV curable.

24. The electronic display of claim 20 wherein the insulator does not substantially increase the resistance of the plurality of resistors at ambient temperature and humidity after curing the insulator.

25. The electronic display of claim 23 wherein the insulator comprises an acrylate based material.

26. The electronic display of claim 25 wherein the insulator includes a photoinitiator.

27. The electronic display of claim 26 wherein the insulator includes silicone and talc.

28. The electronic display of claim 26 wherein the insulator is screen printable.

29. The electronic display of claim 28 wherein the insulator is substantially free of solvent.

30. The electronic display of claim 28 wherein the insulator is substantially free of epoxy.

31. A method of making a resistive touch screen having a base layer, a plurality of electrodes of the base layer separated by a resistor, and an insulator coupled to the resistor, the method comprising:
applying the insulator to the resistor;
wherein the insulator does not substantially increase the resistance of the resistor at ambient temperature and humidity.

32. The method of claim 31 wherein the resistance of the plurality of resistors increases by less than about 30% at 60° C. and 95% RH after two weeks.

33. The method of claim 32 wherein applying the insulator comprises screen printing the insulator.

34. The method of claim 33 further comprising curing the insulator with UV radiation.

35. A resistive touch screen comprising:
a base layer coupled to a flexible layer by a fastener;
a linearization region comprising a plurality of resistors between a first conductor and a second conductor for reducing a bow of a voltage gradient between the first conductor and the second conductor;
an insulator means for maintaining the resistance of the plurality of resistors.

36. The touch screen of claim 35 wherein the resistance of the plurality of resistor is increased by the insulator means by less than about 30% at 60° C. and 95% RH after two weeks.

37. The touch screen of claim 36 wherein the insulator means comprises an acrylate based material that is UV curable.
